(19) United States
(12) Patent Application Publication
(10) Pub. No.: US 2012/0193003 A1
(43) Pub. Date: Aug. 2, 2012

(54) INTERIOR TIRE SURFACE HAVING DEPTH INDICATOR

(75) Inventors: Cesar Zarak, Simpsonville, SC (US); Nathan Panning, Simpsonville, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/018,396

(22) Filed: Jan. 31, 2011

(51) Int. Cl. B60C 11/24; B24B 1/00

(52) U.S. Cl. 152/154.2; 451/28

(57) ABSTRACT

Embodiments of the present invention include a tire having depth indicators arranged along an interior tire surface and methods of removing material from an interior tire surface. Particular embodiments of the present invention include a tire having a pair of beads spaced axially along a rotational axis of the tire; an inner exposed surface extending between each pair of beads and annularly about the rotational axis of the tire, the inner exposed surface being spaced from an exterior surface of the tire by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness. Particular embodiments include a bladder for forming the tire.

### BACKGROUND OF THE INVENTION

1. Field of the Invention

This invention relates generally to methods and apparatus identifying the depth of reinforcements arranged below an interior or inner exposed tire surface.

2. Description of the Related Art

To apply a patch along an inside surface of a tire, various treatments are generally required. While typically a certain amount of tire material or other features must be removed from the inside of the tire, several different preparations are employed depending upon the patch and application. For example, applying a patch requires removal of a non-stick coating from the interior surface of the tire, removal of dirt or debris, removal of a bladder imprint, removal of a sufficient depth of material desired for installing the patch, applying a texture to the surface for receipt of the patch, removal of an old patch or other features, and/or other treatments. As used herein, “patch” shall be understood to include a material being added to the interior surface of the tire for purposes of repair as well as a device carrying various components such as e.g., electronic sensors, RFIDs, etc.

In preparing for patch application, various material removal tools and manual techniques may be used for treating the inside surface of the tire. For example, removal of tire material may be performed manually using a material removal tool, such as a grinding or abrading tool, e.g., an abrasive wheel or similar tool. Such material removal operations can be particularly challenging when preparing an interior tire surface, which requires operating the grinding tool inside the tire. It is often difficult to determine how deep an operator can remove elastomeric material before contacting any underlying reinforcement, especially when it is desirous to remove material as deeply as possible without damaging any underlying reinforcement to maintain the integrity of the tire construction. Accordingly, it would be desirous to provide a mechanism and method for determining the depth of the underlying reinforcement before material removal operations begin.

### SUMMARY OF THE INVENTION

The present invention includes a tire having one or more depth indicators arranged along an interior exposed surface of the tire, the depth indicators corresponding to a depth or distance extending into a thickness of the tire from the interior expose tire surface. Particular embodiments of the tire comprise a pair of beads spaced axially along a rotational axis of the tire and an inner exposed surface extending between each pair of beads and annularly about the rotational axis of the tire, the inner exposed surface being spaced from an exterior surface of the tire by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness.

In other embodiments, the present invention includes a method of removing material during tire repair operations. Particular embodiments of such method include the step of providing a tire, the tire comprising: a pair of beads spaced axially along a rotational axis of the tire and an inner exposed surface extending between each pair of beads and annularly about the rotational axis of the tire, the inner exposed surface being spaced from an exterior surface of the tire by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness. Further steps may include identifying a feature of the depth indicator and determining a local inward distance corresponding with the feature. Additional steps of such method may include removing elastomeric material from the inner surface to a depth associated with the local inward distance determined in the previous step.

Particular embodiments of the present invention include a tire molding bladder comprising: a flexible body having an outer exposed surface for engaging an inner exposed tire surface during molding operations, the outer exposed surface including a depth indicator form for creating a depth indicator along the inner exposed surface of the tire, the depth indicator form having dimensions sufficient to form a depth indicator having particular dimensions, one of the dimensions of the depth indicator correlating to a desired local inward distance extending from the inner surface of the tire to a depth within an elastomeric layer of the tire. Particular embodiments include the bladder having a plurality of depth indicator forms arranged along the outer exposed bladder surface, the plurality of depth indicator forms including a plurality of radial depth indicator forms extending lengthwise in a generally radial direction of the bladder. Further embodiments provide that the depth indicator comprises a protrusion or indicia.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a front perspective view of a tire having depth indicators arranged along an inner exposed tire surface, according to an embodiment of the invention;

FIG. 2 is a partial perspective section view of the tire of FIG. 1, showing depth indicators forming ridges along the inner exposed tire surface, where a first plurality of the ridges extend in a generally radial direction of the tire (i.e., radially) in accordance with an embodiment of the invention;

FIG. 3 is a cross-sectional view of the tire of FIG. 2 taken along line 3-3 to show further details of the depth indicators, including a variable depth indicator height, according to an embodiment of the invention;

FIG. 4 is a partial sectional view of the tire of FIG. 2 taken from Section 5, thereby showing further details of the depth indicators according to an embodiment of the invention;

FIG. 5 is a side view of a tire section, such as the tire section of FIG. 3, showing the lengthwise extension of the depth indicators along the inner surface of the tire with additional circumferential depth indicators extending lengthwise in a circumferential direction of the tire according to an embodiment of the invention;

FIG. 6A is a table showing the corresponding relationship between a dimension of the depth indicator and a known local inward distance from the tire inner surface by employing an exemplary formula, where such inward distance may equal, for example, the local thickness of the elastomeric layer extending between the inner exposed tire surface and an embedded reinforcement according to an embodiment of the invention;

FIG. 6B is a table showing the corresponding relationship between a dimension of the depth indicator and a known local inward distance from the tire inner surface by employing an exemplary formula, where such inward distance may equal, for example, the local thickness of the elastomeric layer extending between the inner exposed tire surface and an embedded reinforcement according to an embodiment of the invention;

FIG. 7 is a partial sectional view of the tire undergoing tire repair operations, wherein a material abrading tool is removing a portion of the elastomeric layer to a depth associated with an adjacent depth indicator according to an embodiment of the invention.

FIG. 8 is a partial perspective view of an interior tire surface having an alternative depth indicator forming a local protrusion having particular dimensions used to indicate a local inward distance from the interior tire surface;

FIG. 9 is a partial perspective view of an interior tire surface having an alternative depth indicator forming a reference character used to indicate a local inward distance from the interior tire surface;

FIG. 10 is a sectional view of a tire molding device, wherein a tire is arranged between a pressurized molding or curing bladder and a mold, the bladder including recesses to form the ridges along the inner exposed surface of the tire according to an embodiment of the invention; and,

FIG. 11 is perspective view of an annular bladder shown in partial cross-section in FIG. 10, the bladder having depth indicator forms comprising recesses arranged along an outer bladder surface for forming corresponding depth indicators comprising ridges along the inner exposed surface of the tire according to a particular embodiment of the invention.

### DETAILED DESCRIPTION OF PARTICULAR EMBODIMENTS

Particular embodiments of the present invention concern formation and placement of depth indicators arranged along an interior exposed surface of a tire, which is also referred to herein as the “inner” exposed surface. Each depth indicator includes at least one feature or characteristic from which a distance extending inwardly from the interior tire surface (also referred to as the “inward distance”) is determinable. The inward distance may equal (1) the depth of the elastomeric layer (i.e., the distance extending between the interior tire surface and a reinforcement submerged below the interior tire surface; or (2) a depth or distance to which material may be removed from the interior tire surface without damaging any reinforcement submerged or embedded below the interior tire surface, where such distance is equal to or less than the distance between the inner tire surface and the nearest submerged reinforcement. The depth or distance referred to in item (2) above is also referred to as the “material removal depth.” In particular embodiments, the feature is a height, width, length, depth, diameter, or other physical or measureable feature having a particular dimension corresponding with an inward distance. In particular embodiments, depth indicator has a feature corresponding to an inward distance that is local or near the feature. In other embodiments, the feature corresponds to an inward distance that is determinable not by measuring any feature but by simply by identifying or observing the presence of the feature or features. Other embodiments of the invention include (1) a tire curing or molding bladder for forming a tire having depth indicators arranged along an inner surface of the tire, (2) methods of forming such a tire; and, (3) methods of removing material from the tire.

Particular embodiments comprise a method of removing material during tire repair operations. Such methods may include a step of providing a tire comprising: a pair of beads spaced axially along a rotational axis of the tire; an outer exposed surface extending between each pair of beads, the outer or external exposed surface including a tread surface extending annularly about the rotational axis of the tire; and, an inner or interior exposed surface extending between each pair of beads and annularly about the rotational axis of the tire, the inner exposed surface being spaced from the outer surface by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness. In particular embodiments, the feature of the depth indicator has a dimension corresponding to the inward distance. The inward distance may equal a thickness of elastomeric material located adjacent the depth indicator, the thickness of elastomeric material extending between the inner exposed surface and a reinforcement embedded within the tire thickness. In other variations, the inward distance is less than a thickness of elastomeric material extending between the inner exposed surface and a reinforcement embedded within the tire thickness. In various embodiments, depth indicator may comprise a ridge or a recess extending lengthwise or longitudinally in any direction along the interior tire surface. In other embodiments, the depth indicator may comprise any desired form or include any desired feature. For example, depth indicator may include or form a protrusion, marking, or indicia. A plurality of depth indicators may be arranged along the interior surface, which may include a plurality of radial depth indicators extending in a generally radial direction of the tire. A plurality of circumferential depth indicators may also be included, each of which extend in a generally circumferential direction of the tire.

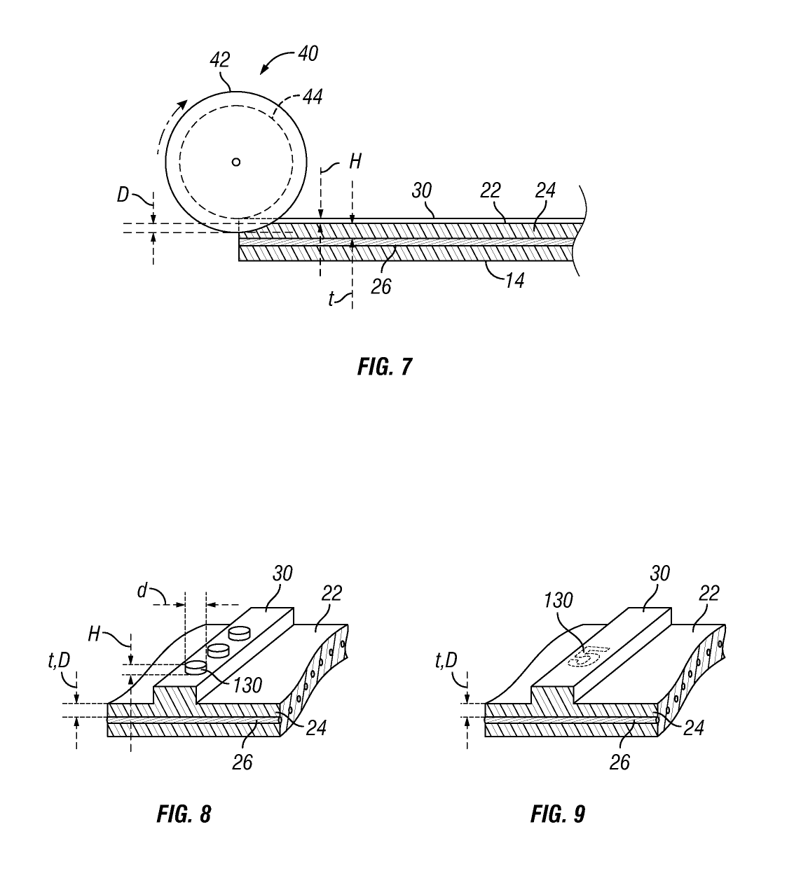

Further steps of such method may include the step of identifying the feature of the depth indicator. In particular embodiments, the step of indentifying comprises measuring the feature of the depth indicator to identify, obtain, or quantify a dimension of the depth indicator. The dimension may quantify a feature of the depth indicator, such as, a depth, height, or width of the depth indicator, for example. It follows that the step of measuring may be performed explicitly by actually measuring the feature by any method or device known in the art capable of measuring any physical dimension or property of the depth indicator. For example, a measurement device may comprise a dial caliper, loupe, or laser measuring device. The step of indentifying or measuring may also be performed implicitly without performing any actual measurement, such as, for example, when a material removal tool or the like removes material from the inner exposed tire surface to a depth determined automatically as the tool engages and/or translates along the depth indicator. See FIG. 7, for example. In other words, the step of measuring may be implicitly performed when a material removal tool engages the depth indicator and reacts by automatically removing material from the inner exposed surface to a desired depth equal to an inward distance to which depth indicator corresponds.

Further steps of such method may include the step of determining the inward distance corresponding with the feature. In particular embodiments, the step of determining includes determining a local inward distance associated with the feature. These steps may be performed explicitly by employing a particular formula or equation that associates the measured dimension with the inward distance. Exemplary formulas are discussed further below. The steps of determining a local inward distance may be performed without employing any calculation, but instead by simply correlating a depth indicator feature identified or observed in the prior step, whereby the mere existence of a particular feature correlates to an inward distance. The step of determining a local inward distance associated with a dimension may also be performed implicitly, such as discussed above while translating a tool along a depth indicator, for example, which may occur in particular embodiments while implicitly performing the step of identifying or measuring.

Further steps of such method may also include, in particular embodiments, the step of removing elastomeric material from the inner surface to a depth associated with the local inward distance determined in the previous step. Material may be removed using any known material removal device, including a bladed grooving iron or a rotary abrading tool, for example. Any such device may include a guide wheel that engages a depth indicator to assist in controlling the material removal tool during its operation.

Particular embodiments include a method of forming a tire comprising the step of inserting a green (i.e., uncured) tire into a mold, a molding bladder being positioned within an interior cavity of the tire; internally pressurizing the molding bladder to expand the bladder against an inner exposed surface of the green tire, the bladder including a depth indicator form for creating a depth indicator along the interior exposed surface of the tire, the depth indicator form having dimensions sufficient to form a depth indicator having a particular feature, the feature correlating to an inward distance extending from the interior exposed tire surface to a depth within an elastomeric material layer extending between the interior tire surface to one or more reinforcements submerged within a thickness of the tire; and, curing the green tire to form a cured tire including the desired depth indicator. Particular embodiments may provide that the feature of the depth indicator correlates to the thickness of elastomeric material layer.

Exemplary embodiments of a tire and methods of forming a tire having depth indicators along an inner exposed surface are discussed in further detail below.

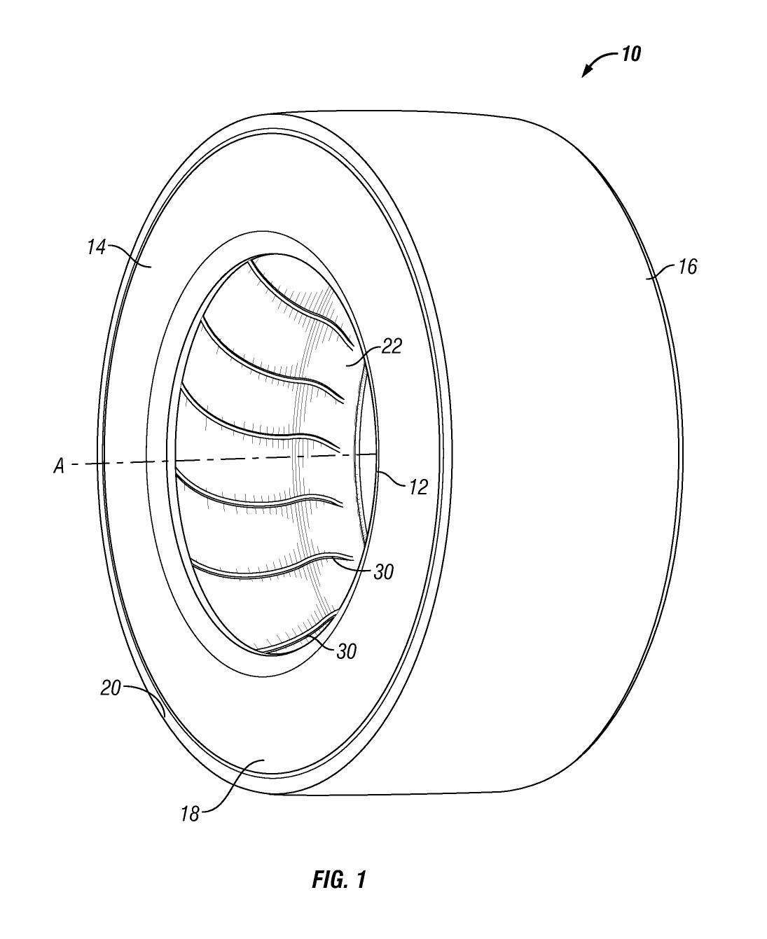

With reference to FIG. 1, an exemplary embodiment of a tire 10 having depth indicators 30 is shown. Tire 10 generally comprises a pair of beads 12 spaced laterally along the rotational axis A of the tire. A pair of opposing sidewalls 14 extend radially from the beads 12 to a tread 16 of the tire, the tread 16 extending annularly about the rotational axis A. A shoulder area 18 is arranged between the tread 16 and each sidewall 14. The tire 10 also includes an outer or exterior exposed surface 20 extending generally from bead to bead and includes the tire tread. The tire 10 also includes an inner (i.e., interior) exposed surface 22 that extends within the tire from bead 12 to bead 12 and under the tread 16, where the inner 22 and outer 20 exposed surfaces are separated by a thickness of the tire. In use, the outer or exterior surface 20 is exposed to atmosphere while the inner or interior surface 22 partially forms the pressurization chamber between the tire and wheel.

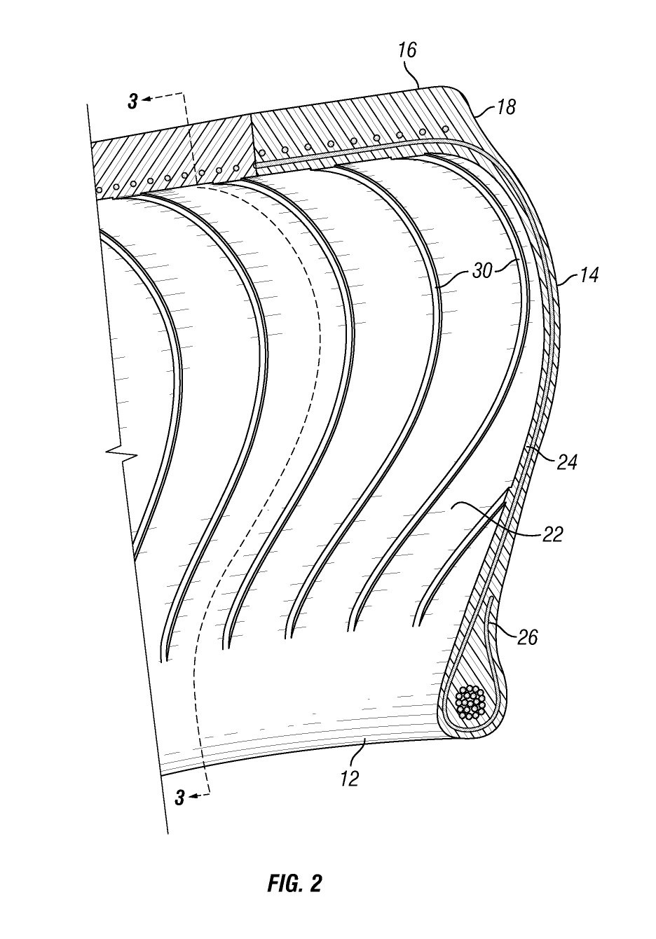

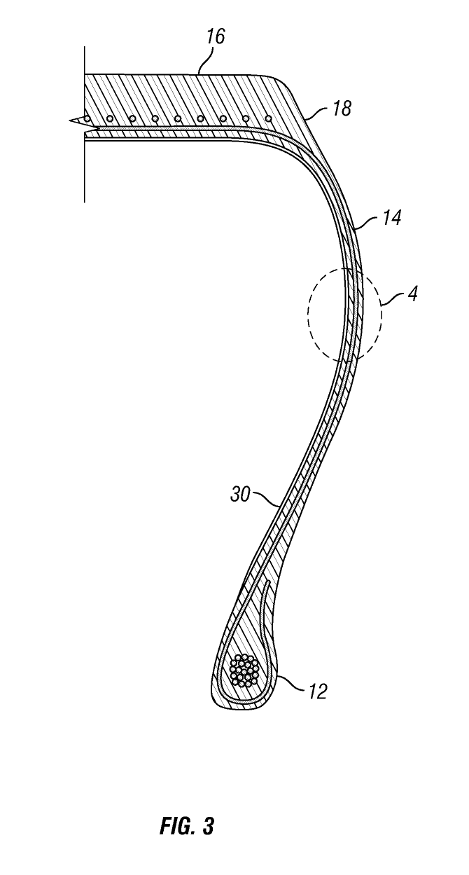

As can be seen in FIG. 1, the interior exposed surface 22 includes a plurality of (or one or more) depth indicators 30, which are shown more clearly in FIGS. 2-5. Depth indicators 30 are arranged along interior tire surface 22. Below surface 22 is a body of elastomeric material generally referred to as an elastomeric layer 24. Elastomeric layer 24 extends between interior surface 22 and reinforcements 26 arranged (i.e., submerged or embedded) within the thickness of the tire, and may comprise any one or more different elastomeric materials, each of which may form a layer within elastomeric layer 24. Elastomeric material may comprise, for example, natural or synthetic rubber and any other suitable polymeric material, including thermoset polymers, for example.

In the embodiments shown, depth indicators 30 form ridges extending outwardly from the interior exposed surface 22. In other embodiments, depth indicators 30 are recesses extending into a thickness of the elastomeric layer 24. It is understood, however, that depth indicators may comprise any form having features or characteristics correlating to a local depth or distance extending into a thickness of elastomeric material 24. For example, a feature may comprise a height H, width W, or depth of a depth indicator 30, which may be measured explicitly or implicitly or a feature or characteristic may be identified or observed to explicitly or implicitly determine a local inward distance or depth D extending into layer 24 from surface 22. The distance or depth D may equal: (1) the local thickness t of the elastic layer 24, which is the local distance from the interior tire surface 22 to the reinforcement 26 or the local maximum depth to which the operator can remove material without damaging the embedded reinforcement 26; or (2) any other local desired distance or depth from tire surface 22 to which material can be removed without damaging the embedded reinforcement 26 (which may be less than layer thickness t). The term “local” means that the corresponding thickness, distance, or depth of layer 24 referred to previously is near or adjacent the dimension, feature, or characteristic of an associated depth indicator 30. Now, by knowing the meaning or significance of any feature or characteristic of depth indicator 30, such as a dimension DIM associated with a feature, the depth or distance D can be determined explicitly or implicitly. This may be useful, for example, when having to remove material from the interior tire surface to install a tire repair patch during tire repair operations.

With continued reference to the embodiments of FIGS. 1-2, the plurality of depth indicators 30 extend laterally across the tire between beads 12 in a generally radial direction of the tire. It is understood, however, that depth indicators may extend lengthwise in any direction of the tire, including any direction from a true radial direction of the tire to a true circumferential direction of the tire. For example, with reference to FIG. 5, a plurality of circumferential indicators 34 are shown extending in a true circumferential direction of the tire (i.e., where such indicators extend concentrically or along a radius rₒ having an origin located along the rotational axis A of the tire), in addition to a first plurality of radial depth indicators 32 extending in a true radial direction of the tire (i.e., extending perpendicular to a line tangent to a diameter having an origin arranged along the tire's rotational axis). It is understood that radially extending depth indicators 30, 32 may deviate from a true radial direction there from by an angle αᵣ, while circumferentially extending depth indicators 30, 34 may deviate from a true circumferential direction by an angle α_{c}. In summary, a depth indicator may extend lengthwise in any direction of the tire, and may be associated with one of a plurality of depth indicators also extending generally in the same direction of the tire. The tire may also employ one or more pluralities depth indicators, where each plurality of indicators extend in a particular direction of maintain particular dimensions, features, or characteristics different from other pluralities of depth indicators (see FIG. 5 for example). Depth indicators 30 may (or may not) extend continuously (as shown) or in spaced-apart segments in a lengthwise direction, whether or not from bead 12 to bead 12 or annularly around the tire 10.

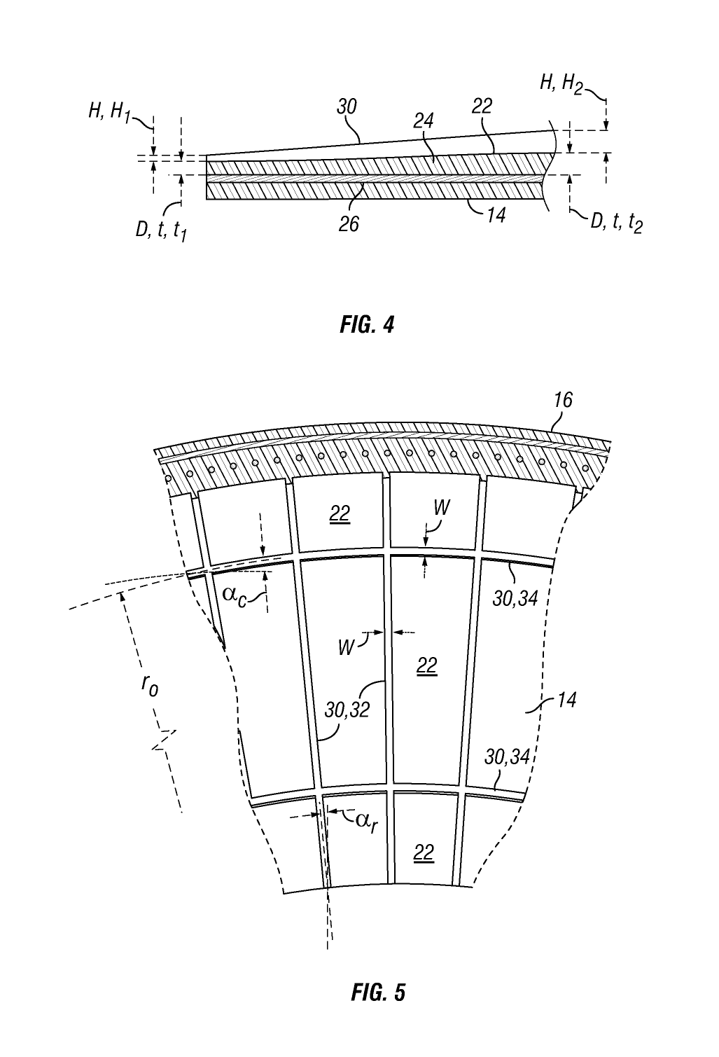

With specific reference to FIGS. 4 and 5, each depth indicator 30 has features comprising width W and height H (or a depth in other embodiments when indicator forms a recess in lieu of a ridge), each of which may be constant or variable along a lengthwise extension of each indicator 30. In instances where the thickness of the elastomeric layer 24 varies in radial and/or circumferential directions of the tire, one or more features of each depth indicator 30 may change to identify the various layer thicknesses. Further, different depth indicators 30 may be arranged at particular locations along inner tire surface 22 to indicate different inward distances D associated with the elastomeric layer 24.

With reference to FIG. 4, for example, the thickness t of layer 24 increases as it extends in a radial direction toward shoulder area 18. Accordingly, the height H of each indicator 30 changes as it approaches the shoulder area to indicate an increase in the thickness t of layer 24. In the embodiment shown, height H changes by increasing with increasing layer thickness t, where indicator height H₁ relates to local layer thickness t₁ and indicator height H₂ relates to local layer thickness t₂ with height H₁ and thickness t₁ each being less than height H₂ and thickness t₂, respectively. In other variations, height H (or any other dimension, such as width W) may be inversely associated with changes to any dimension associated with layer 24, such as decreasing when layer thickness 24 increases, for example. Further, changes in any indicator feature, such as height H or width W, may occur gradually along a length of an indicator (as exemplarily shown in FIG. 4), such as along a linear or curvilinear path, or in constant height or width segments (not shown), which may form an indicator 30 that is stepped in a lengthwise direction. By further example, with reference to FIG. 5, circumferential indicators 34 (when present) may change in width W or height H when arranged within or near the shoulder area to indicate an increase in the elastomeric layer 24 thickness t.

As stated above, in particular embodiments, a feature of a depth indicator 30 is used to identify a desired distance extending inward (also referred to herein as the “inward distance” or the “local inward distance”) from the interior tire surface 22, where such inward distance D may be: (1) the local thickness t of the elastic layer 24, which is the local distance from the interior tire surface 22 to the reinforcement 26 or the local maximum depth to which the operator can remove material without damaging the embedded reinforcement 26; or (2) any other local desired distance or depth from tire surface 22 to which material can be removed without damaging the embedded reinforcement 26 (which may be less than layer thickness t). In operation, the feature is identified and the local inward distance D is determined.

In particular embodiments, the feature is identified by measuring the feature and the local inward distance D determined by performing a known calculation. For example, the height H or width W is measured and is inserted into a formula for determining the local inward distance D. In one example, a the height H or width W is multiplied by a factor C to arrive at the local inward distance D. Factor C may be any value, of which may be constant for the tire or may vary as desired. For example, factor C may be greater or less in the shoulder area 18 than in other locations of the tire, such as the sidewall area 14 or under the tread 16. By further example, the formula may comprises adding or subtracting a known value Y (also referred to as an “offset”) to or from the measured dimension or to or from the product obtained by multiplying the measured dimension with factor C. It is understood that these formulas are mere examples for use in explaining the invention, and that any other desired formula may be utilized to determine a local inward distance D based upon a measured dimension of the depth indicating 30. In particular embodiments, Factor C may vary between particular areas or zones arranged along the tire's inner surface 22, where such zones may be identified by one or more depth indicators, features, characteristics, or markings. With reference to FIG. 5, for example, circumferential depth indicators 34, may separate or identify the boundary of particular zones arranged radially about the tire, for example, each of which may have a different equation for determining the association (i.e., relationship or correlation) between depth indicator 30 and a distance or depth D extending into layer 24 between inner tire surface 22 and a reinforcement 26.

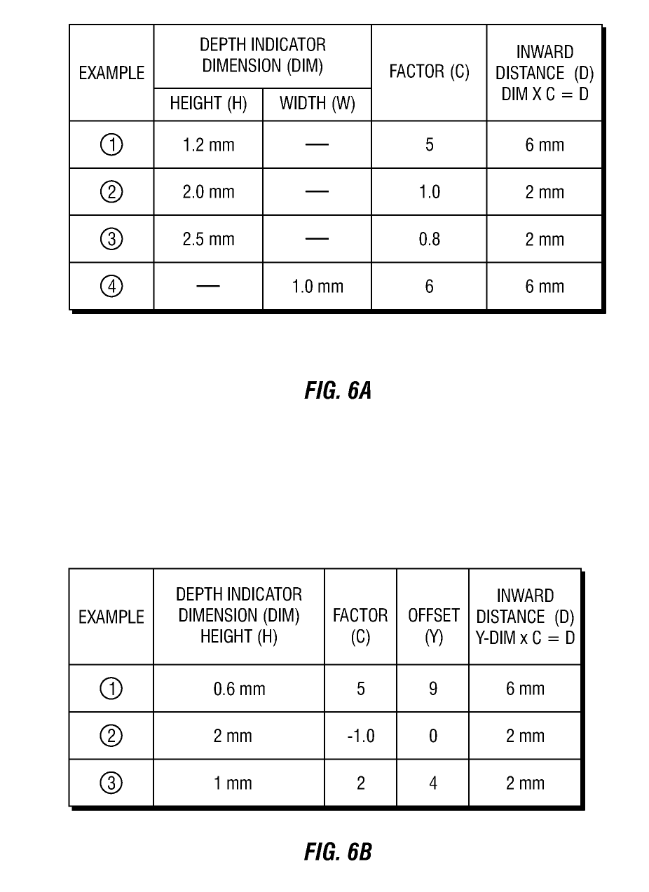

With reference to the chart in FIG. 6A, exemplary calculations are shown to arrive at an intended local inward distance D from inner surface 22. The calculations employ the following formula: depth indicator dimension DIM multiplied by factor C equals inward distance D (DIM×C=D). As suggested herein, depth indicator dimension can be any dimension of the depth indicator, such as the depth indicator height H or width W, for example. With regard to the first example shown, if the depth of a submerged reinforcement 26 is 6 millimeters (mm) from the interior tire surface 22, and if the formed height of a local depth indicator 30 is to be measured at 1.2 mm, a factor of 5 is used to determine (i.e., calculate) the local inward distance D of 6 mm (equal to the depth of the submerged reinforcement or thickness t of the elastomeric layer 24) by multiplying 1.2 mm by 5. In Example 2, a factor of 1 is used to correlate a depth indicator height H of 2.0 to a inward distance D of 2 mm. Example 3 in the chart employs a factor C that is less than 1, whereby height H of 2.5 mm multiplied by a factor C of 0.8 indicates an inward distance D of 2 mm. Use of depth indicator width W is employed in Example 4 to calculate an inward distance of 6 mm (1.0 mm multiplied by a factor C of 6).

With reference to the chart in FIG. 6B, exemplary calculations are again shown to determine an intended local inward distance D from inner surface 22. The calculations employ the following formula: the product of depth indicator dimension DIM multiplied by factor C subtracted from an offset Y equals inward distance D (Y−DIM×C=D). Of course, as suggested above, other variations of this formula may be employed, such as Y+DIM×C=D, DIM×C+Y=D, and DIM×C+Y=D. In Example 1 of the chart, an offset Y of 9 and a factor C of 5 are used to calculate a local inward distance D of 6 mm based upon a depth indicator height H of 0.6 mm. Of course, to arrive at the same result of 6 mm using the formula of FIG. 6A, a factor C of 10 could be employed. Example 2 uses a factor C of −1 and an offset Y of 0 to calculate a local inward distance D of 2.0 mm based upon a depth indicator height H of 2 mm. Finally, Example 3 uses a factor C of 2 and an offset Y of 4 to calculate a local inward distance D of 2.0 mm based upon a depth indicator height H of 1 mm.

By knowing how deep a reinforcement 26 is located from interior tire surface 22 or by knowing how deep material can be removed from interior tire surface 22 without damaging any underlying reinforcement 26, an operator may more assuredly or predictably perform tire repair operations. Often, such as when preparing a tire to receive a tire repair patch, material from the interior tire surface 22 is removed by a material removal tool. A material removal tool may comprise any device known to one of ordinary skill in the art capable of removing material from a tire, such as, for example, a rotary grinder or a bladed grooving iron.

With reference to FIG. 7, for example, a rotary removal tool 40 is shown removing material from elastic layer 24 to a depth equal to the local inward distance D. In the embodiment shown, tool 40 includes a rotary abrasion disk 42 used to remove material from layer 24. A guide wheel 44 is also shown rotating along a depth indicator 30, 32, whereby the depth indicator 30, 32 doubles as a template to guide and control the use of tool 40 during material removal operations. Accordingly, guide wheel 44 may be defined by any appropriately sized diameter to achieve the desired cut depth for disk 42. This can be viewed as an implicit performance of the method step of determining an inward distance when the inward distance is not calculated explicitly, but rather the abrading disk 42 achieves the inward distance as guide wheel 44 engages and translates along a depth indicator 30. And if the depth indicator is not measured, but rather a guide disk is used for an entire tire regardless of any measurement associated with the depth indicator, the use of guide wheel 44 can be viewed as an implicit performance of the method step of measuring the depth indicator. By explicitly or implicitly measuring a dimension of a local or adjacent depth indicator or identifying a particular feature or characteristic of the depth indicator, which is discussed more fully below, is able to determine explicitly or implicitly a dimension of an inward distance D associated with the elastomeric layer 24 as discussed above that equals: (1) the local thickness t of the elastic layer 24, which is the local distance from the interior tire surface 22 to the reinforcement 26 or the local maximum depth to which the operator can remove material without damaging the embedded reinforcement 26; or (2) any other local desired distance or depth extending into elastic layer 24 from tire surface 22, where such distance may be less than layer thickness t. The purpose of item (2) may be, for example, to retain a desired thickness of elastomeric material atop the reinforcement 26 to further reduce the risk that the reinforcement may be damaged during material removal operations. In particular variations, the operator may subtract a thickness from D to allow a desired amount of elastomeric material to remain along reinforcement 26.

Consistent with the prior uses, alternative depth indicators are also contemplated. For example, with reference to FIG. 8, protrusions 130 may be employed either along existing ridges 30, or simply along interior tire surface 22. In the embodiment shown, protrusions 130 form cylinders, but it is understood that other shapes may also be employed, such as cubes or boxes, for example. In the embodiment shown, the outside diameter d or height H of the protrusion maybe used as the depth indicator dimension DIM in any formula generally considered above to determine the intended local inward distance or depth D Likewise, with reference to FIG. 9, an indicia such as a character or symbol 130 may be simply molded into ridge 30 or along interior surface 22. Such character or symbol 130 may either state expressly in numerical form or may represent by reference or correlation the local inward distance or depth D, the factor C and/or the offset Y employed in any formula generally contemplated above, or any other value that may be employed by any other formula employed. Further, a depth indicator or feature thereof may comprise a color, such as colored portion of the elastomeric material arranged along the interior tire surface. A chart may be employed to relate any feature or characteristic, such as a symbol, character, indicia, or color to a corresponding value.

With reference to FIG. 11, according to particular embodiments, each of the depth indicators 30 are formed by a corresponding depth indicator form 54 arranged along an exterior exposed surface 52 of a tire curing bladder 50, the bladder being used for tire molding and curing operations. For example, when depth indicators 30 arranged along the interior tire surface 22 are ridges, the corresponding forms in the exterior bladder surface are recessed grooves appropriately dimensioned and shaped to form the desired ridges. Of course, depth indicator forms 54 may form any desired depth indicator 30. In the embodiments shown, bladder 50 includes a plurality of forms 54 comprising lengthwise extending recesses that form air vents channeling air from between the interior tire surface and the bladder during tire molding and curing operations. The plurality of forms 54 may be arranged in any manner contemplated and to form any arrangement of depth indicators along the interior tire surface 22. Bladder 50 is a flexible membrane comprising elastomeric material and other components known to one of ordinary skill in the art. Bladder 50 is also manufactured in accordance with principles and techniques known to one of ordinary skill.

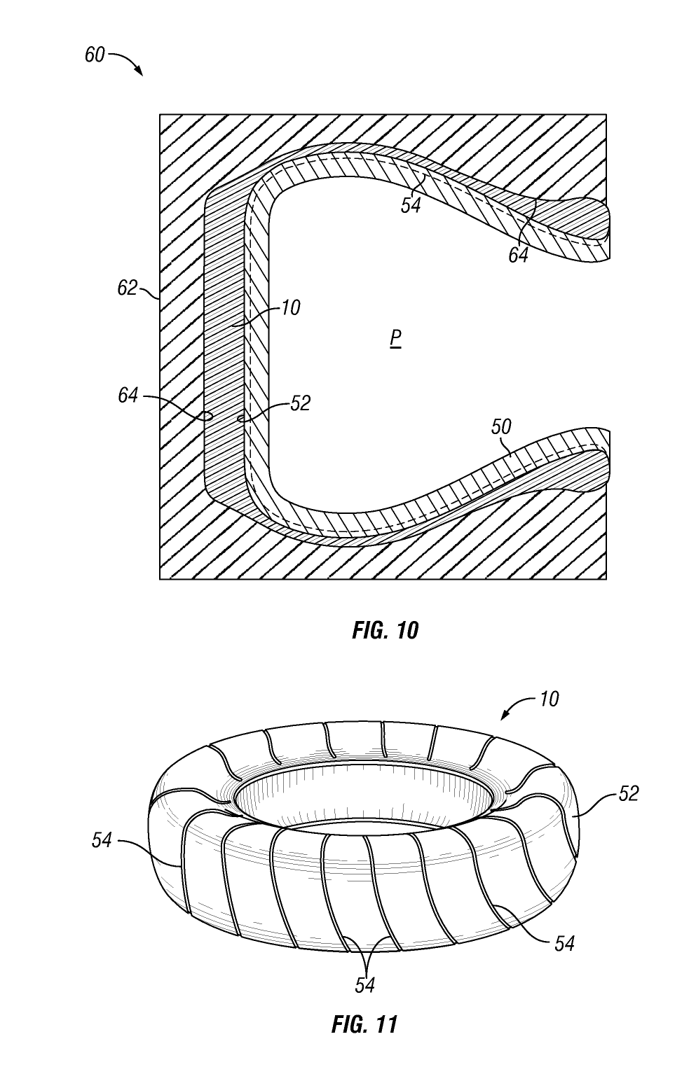

With reference to the exemplary embodiment of FIG. 10, typical tire molding and curing operations include arranging a green (i.e., uncured) tire within a mold 62 of a curing machine 60. A flexible bladder 50 is positioned centrally within the tire 10, the tire being arranged between the bladder and a tire-engaging interior surface 64 of the mold. During tire molding and curing operations, the bladder 50 is pressurized and thereby expands to forcefully engage the interior tire surface 22, whereby corresponding depth indicators 30 are formed along the interior exposed tire surface 22. Because each form 54 molds a corresponding depth indicator 30 into the interior surface 22 of tire 10, each form 54 is dimensioned or sized to achieve the desired dimensions of a corresponding depth indicator 30 when bladder is in an expanded, tire engaging arrangement. Therefore, the size of the form is appropriately sized in an unexpanded, unpressurized arrangement to achieve the desired size and shape when pressurized and expanded into its molding arrangement. The bladder also forces the tire outwardly against the tire molding surface. The molding process continues until the tire is properly shaped and cured.

While this invention has been described with reference to particular embodiments thereof, it shall be understood that such description is by way of illustration and not by way of limitation. Accordingly, the scope and content of the invention are to be defined only by the terms of the appended claims.

What is claimed is:

1. A tire comprising:
a pair of beads spaced axially along a rotational axis of the tire;
an inner exposed surface extending between each pair of beads and annularly about the rotational axis of the tire, the inner exposed surface being spaced from an exterior surface of the tire by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness.

2. The tire of claim 1, wherein the inward distance is a material removal depth equaling a depth to which elastomeric material can be removed without damaging the reinforcement.

3. The tire of claim 1, wherein the feature of the depth indicator has a dimension corresponding to the inward distance.

4. The tire of claim 3, where the dimension corresponds to the inward distance by a factor.

5. The tire of claim 4, wherein the factor corresponds to a feature of a depth indicator.

6. The tire of claim 3, where the dimension varies as the depth indicator extends along the inner exposed surface.

7. The tire of claim 1, where the feature corresponding to the inward distance of the elastomeric material is a height of the depth indicator.

8. The tire of claim 1, where the depth indicator forms a ridge extending outwardly from the inner exposed surface, the ridge having a width and a height and extending lengthwise along inner exposed surface.

9. The tire of claim 8, where the ridge extends lengthwise in a generally radial direction of the tire.

10. The tire of claim 1, where the tire includes a plurality of depth indicators arranged along the inner exposed tire surface.

11. The tire of claim 1, where the depth indicator comprises indicia.

12. The tire of claim 1, where the depth indicator comprises a color.

13. A method of removing material during tire repair operations, the method comprising:
providing a tire, the tire comprising:
a pair of beads spaced axially along a rotational axis of the tire;
an inner exposed surface extending between each pair of beads and annularly about the rotational axis of the tire, the inner exposed surface being spaced from an exterior surface of the tire by a thickness of the tire, the inner surface including a depth indicator having a feature, where the feature of the depth indicator corresponds to an inward distance extending from the inner exposed surface into a thickness of elastomeric material, the elastomeric material extending between the inner exposed surface and a reinforcement embedded within the tire thickness;
identifying the feature of the depth indicator;
determining the inward distance corresponding with the feature;
removing elastomeric material from the inner surface to a depth associated with the local inward distance determined in the previous step.

14. The method of claim 13, wherein the step of identifying includes measuring a feature of the depth indicator to obtain a dimension corresponding to an inward distance, the dimension being used to perform the step of determining.

15. The method of claim 14, wherein the step of determining is performed by calculating the inward distance using the dimension measured in the step of identifying.

16. The method of claim 13, wherein the step of removing material is performed using a rotary abrading tool.

17. The method of claim 13, where the depth indicator forms a ridge extending outwardly from the inner exposed surface, ridge having a width and a height and extending lengthwise along the inner exposed surface.

18. The method of claim 13, where the tire includes a plurality of depth indicators arranged along the inner exposed tire surface.

19. The method of claim 13, where the depth indicator comprises indicia.
